(19) United States
(12) Patent Application Publication
(10) Pub. No.: US 2008/0097631 A1
(43) Pub. Date: Apr. 24, 2008

(54) Home Network System

(75) Inventors: Seung-Myun Baek, Kyungsangnam-do (KR); Koon-Seok Lee, Kyungsangnam-do (JP); Hwan-Jong Choi, Busan (KR); Yong-Tae Kim, Kyungsangnam-do (JP); Feel-Young Koo, Busan (JP); Ja-In Koo, Kyungsangnam-do (KR); Seong-Hwan Kang, Kyungsangnam-do (KR)

Correspondence Address: MCKENNA LONG & ALDRIDGE LLP, 1900 K STREET, NW, WASHINGTON, DC, 20006, US

(73) Assignee: LG ELECTRONICS INC., Seoul (KR)

(21) Appl. No.: 10/571,755

(22) PCT Filed: Jan. 20, 2004
(86) PCT No.: PCT/KR04/00104

§ 371 Date: Sep. 18, 2007

(30) Foreign Application Priority Data
May 30, 2003 (KR) 10-2003-0034962

(51) Int. Cl. G06F 17/00

(52) U.S. Cl. 700/90

(57) ABSTRACT

The present invention discloses a home network system (1) which can provide an efficient address system for home appliances by using a dynamic address field selectively including at least two different kinds of logical address codes. The home network system (1) includes at least one slave device (40), and a master device (30) connected to the slave devices (40) through a predetermined network (20), the master device (30) and the slave device (40) distinguishing each other by an address field including a dynamic address field selectively having at least two different kinds of logical address codes to distinguish a plurality of slave devices (40) and master devices (30).

### TECHNICAL FIELD

The present invention relates to a home network system, and more particularly to, a home network system which can provide an efficient address system for home appliances by using a dynamic address field selectively including at least two different kinds of logical address codes.

### BACKGROUND ART

Home automation for automatically controlling home appliances at home or remotely has almost reached a commercial use stage. At its early stage, the home automation separately controlled each home appliance by using a telephone or infrared rays, and did not connect the home appliances. However, there has been suggested a method for building a network of home appliances by using a communication means, and collectively managing the network by using a controller.

FIG. 1 is a structure view illustrating a general home network system. Referring to FIG. 1, a home network connects various digital home appliances so that a user can always enjoy convenient, safe and economical life services inside or outside the house.

As factors of the advent of the home network, refrigerators or washing machines called white home appliances have been gradually digitalized due to development of digital signal processing techniques, and new information home appliances have been made due to rapid development of home appliance operating system techniques and high speed multimedia communication techniques.

Here, an IT network is built to exchange data between a personal computer and peripheral devices o r provide internet services, and an AV network i s built between home appliances using audio or video information. In addition, a living network is built to simply control home appliances, such as home automation or remote meter reading, and may be comprised of a refrigerator, washing machine, microwave oven, electric lamp, gas alarm, air conditioner and telephone.

The home network system includes a master device which is a home appliance for controlling an operation of the other home appliances or monitoring a status thereof, and a slave device which is a home appliance having a function of responding to the request of the master device and a function of notifying a status change according to properties of the home appliances or other factors. Here, the home appliances (or new devices) include home appliances for the living network service such as a washing machine and a refrigerator as well as home appliances for the IT network service and the AV network service.

The conventional home network system does not provide an address system for distinguishing the plurality of home appliances.

### DISCLOSURE OF THE INVENTION

An object of the present invention is to provide a home network system which uses an address system for distinguishing a plurality of home appliances.

Another object of the present invention is to provide a home network system which uses an address system for indicating different kinds of logical address codes in one field.

Yet another object of the present invention is to provide a home network system which can collectively control and monitor home appliances in a cluster according to a predetermined standard.

In order to achieve the above-described objects of the invention, there is provided a home network system including: at least one slave device; and a master device connected to the slave devices through a predetermined network, the master device and the slave device distinguishing each other by an address field including a dynamic address field selectively having at least two different kinds of logical address codes to distinguish a plurality of slave devices and master devices.

Preferably, the address field further includes a fixed address field having a product code provided for the slave device and the master device.

Preferably, the fixed address field further includes a network code field.

Preferably, the fixed address field is stored in a nonvolatile memory before the master device and the slave device are connected to the home network system.

Preferably, the logical address code is a device code for distinguishing a plurality of slave devices and master devices of the same kind in the home network system.

The device code is set by the master device.

Preferably, the logical address code is a cluster code for clustering the slave device and the master device according to a predetermined standard.

Preferably, the standard is an installation area of each device.

Preferably, the standard is a user of the devices.

Preferably, the address field further includes a flag for indicating whether the logical address code of the dynamic address field is a device code or cluster code.

Preferably, the master device and the slave device store the device code and the cluster code in the nonvolatile memory.

According to one aspect of the invention, in a storage medium for storing an address field of a home network system, the address field used in the home network system comprised of at least two home appliances includes a fixed address field having a product code provided for the home appliances, and a dynamic address field selectively having at least two different kinds of logical address codes for distinguishing the home appliances.

### BRIEF DESCRIPTION OF THE DRAWINGS

The present invention will become better understood with reference to the accompanying drawings which are given only by way of illustration and thus are not limitative of the present invention, wherein:

FIG. 1 is a structure view illustrating a general home network system;

FIG. 2 is a view illustrating a state where a new device is connected to a home network system in accordance with the present invention;

FIG. 3A is a structure view illustrating a constitutional device installed in a master device of FIG. 2;

FIG. 3B is a structure view illustrating a constitutional device installed in the new device of FIG. 2; and

FIGS. 4A to 4C show address systems used in the home network system in accordance with the present invention.

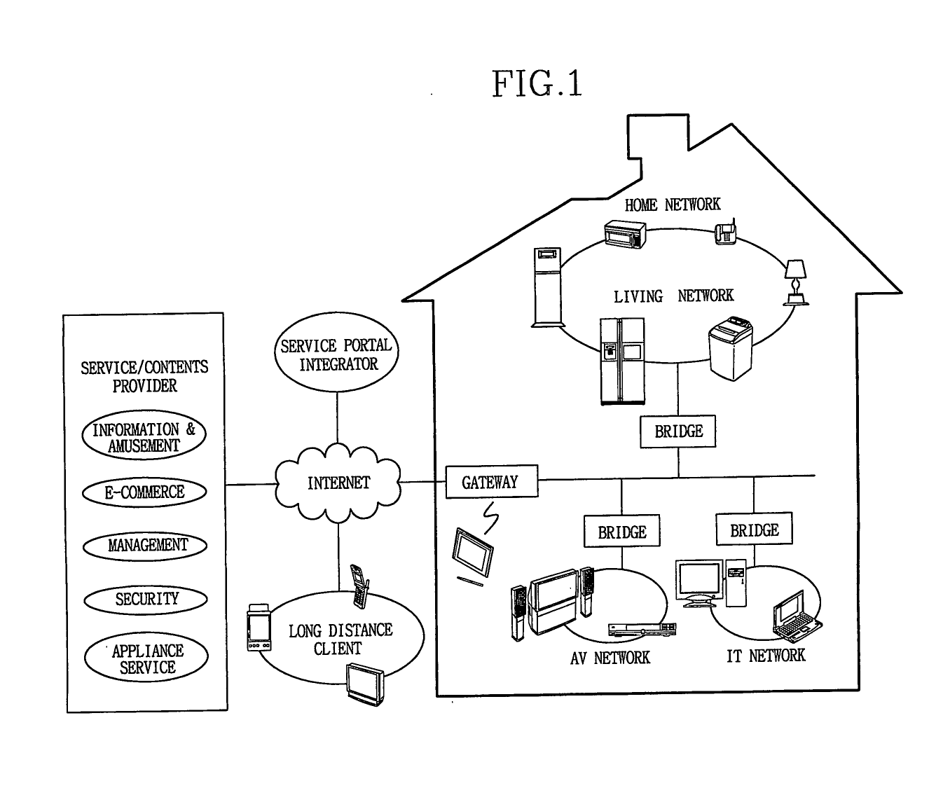

### BEST MODE FOR CARRYING OUT THE INVENTION

A home network system in accordance with the present invention will now be described in detail with reference to the accompanying drawings.

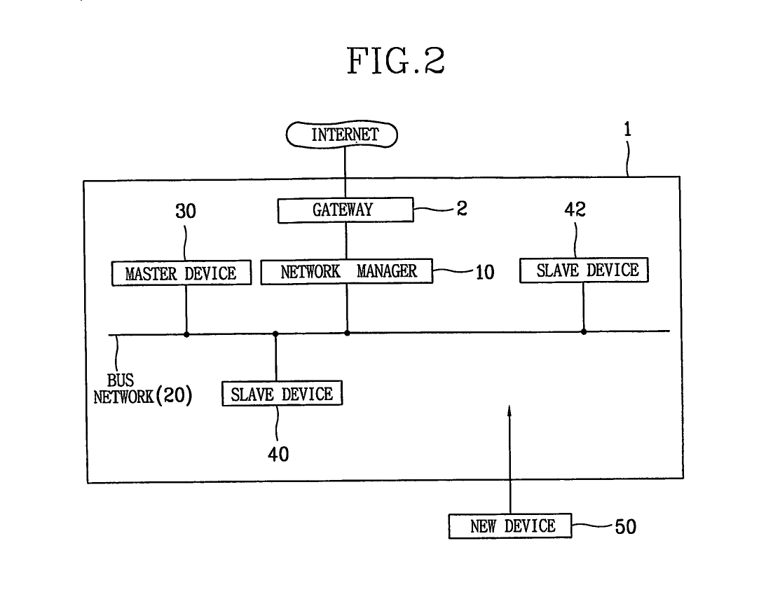

FIG. 2 is a view illustrating a state where a new device is connected to the home network system in accordance with the present invention. Referring to FIG. 2, the home network system 1 includes at least o ne m aster device 30 and slave device 40 and 42 connected through a bus network 20. The home network system 1 further includes a gateway 2 for access to an external network, and a network manager 10 connected to the gateway 2, for providing an internet service and performing environment setting and resetting functions of home appliances in the home network system 1. FIG. 2 shows a process of registering a new device 50 to the home network system 1.

Here, the master device 30 performs the same functions as the general master device, and the network manager 10 performs similar functions to the master device 30 except for the internet service. For conveniences' sake, there are presumed that the network manager 10 performs functions such as a bridge for the internet service, and that only one master device 30 exists in the home network system 1.

The bus network 20 can be a wire medium such as a specially-installed line, or a previously-installed power line or telephone line, or a wireless transmission medium. However, still referring to FIG. 2, the home network system 1 composes a closed network for connecting home appliances of one house through a wire or wireless transmission medium. At this time, the closed network includes a physically-connected but logically-divided network.

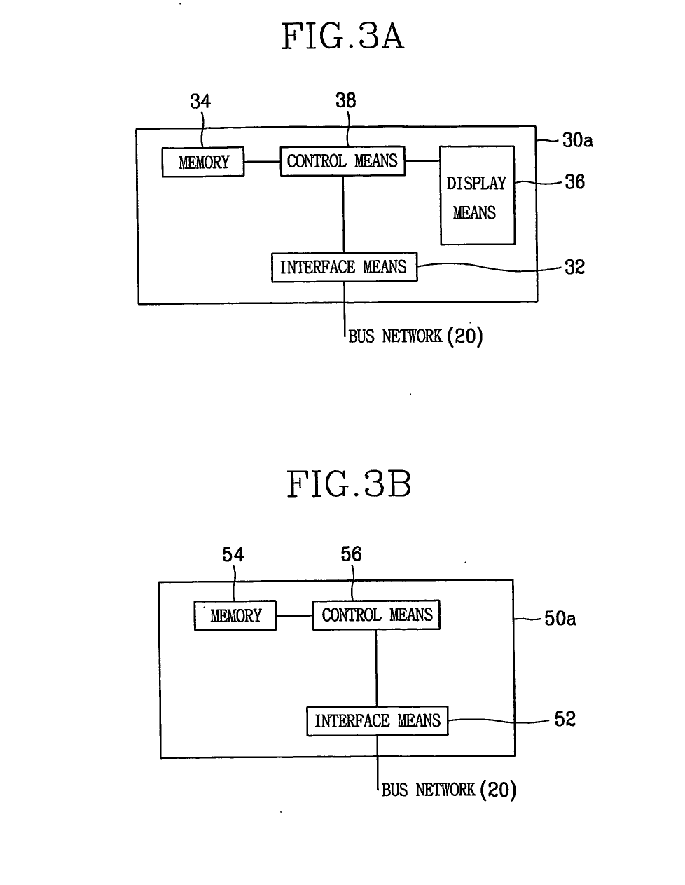

FIG. 3A is a structure view illustrating a constitutional device installed in the master device of FIG. 2. As illustrated in FIG. 3A, the master device 30 includes a constitutional device 30a having an interface means 32 for access to the bus network 20, a memory 34 for storing product information and product address information of the slave devices 40 and 42, a display means 36 for displaying information to the user, and a control means 38 for controlling the interface means 32, the memory 34 and the display means 36, so that the new device 50 can be registered in the home network system 1.

The network manager 10 further includes an interface means (not shown) for access to the gateway 2.

Here, when the information of the slave devices 40 and 42 stored in the memory 34 includes functional properties and performance of each product, it also includes addresses for distinguishing the devices in the home network system 1, which will later be explained.

FIG. 3B is a structure view illustrating a constitutional device installed in the new device of FIG. 2. As shown in FIG. 3B, the new device 50 includes a constitutional device 50a having an interface means 52 for access to the bus network 20, a memory 54 for storing product information and initial address information of the new device 50, and a control means 56 for controlling the interface means 52 and the memory 54 so that the new device 50 can be registered in the home network system 1.

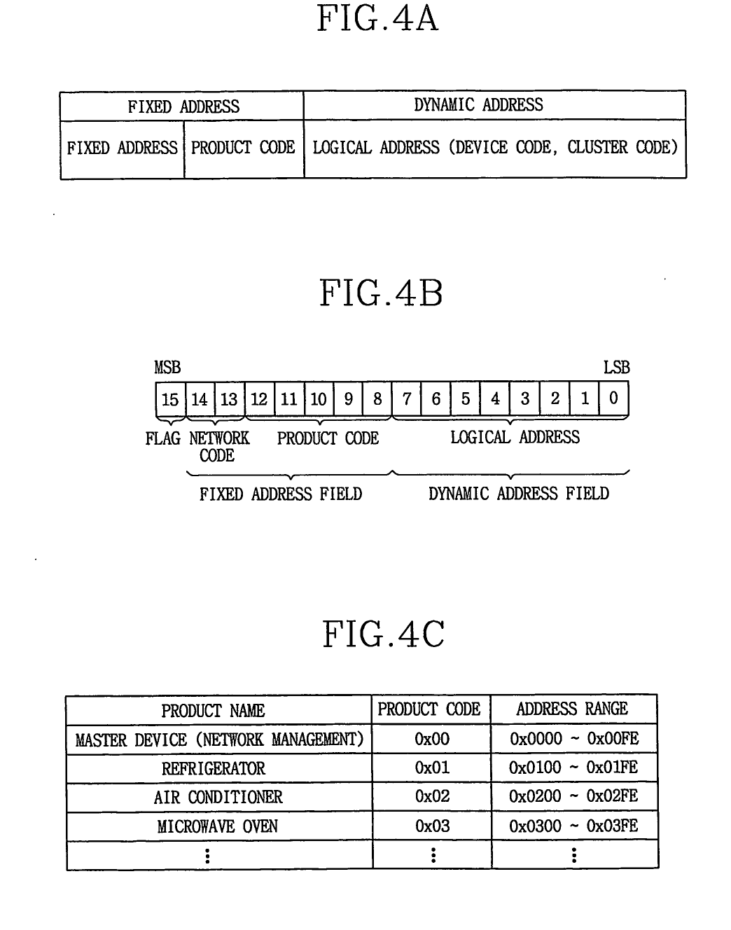

FIGS. 4A to 4C show address systems used in the home network system in accordance with the present invention.

FIG. 4A is a structure view illustrating an address field used in the home network system 1 in accordance with the present invention. As depicted in FIG. 4A, the address field includes a fixed address field having a fixed value, and a dynamic address field selectively having at least two kinds of logical address codes according to a predetermined flag.

The fixed address field basically includes a product code and additionally includes a network code.

In detail, the product code is a unique value for distinguishing a basic function of a product, and a non-changeable physical address assigned to the product in shipment. Same kind of products have the same product code. The field including the product code becomes the fixed address field.

The network code classifies the master device 30 and the slave devices 40 and 42 in the home network system 1 according to kinds or properties of the products, and designates the groups of the products. For example, the devices of the home network system 1 can be classified into a living network group, a television network group, a PC group and a home network group. The living network group includes a white home appliance, electric lamp, security system and health equipment, the television network group includes a television, audio and video, the PC group includes a personal computer, scanner and fax, and the home network group includes a network manager. Here, the network codes for each group can be set as ‘0’ for the living network group, ‘1’ for the television network group, ‘2’ for the PC group and ‘3’ for the home network group, respectively. The network codes are also fixed codes which are not changed by kinds or properties of the products.

The dynamic address field selectively includes one of a device code and a cluster code which are logical address codes.

In detail, the device code is a logical address code for distinguishing the devices having the same product code. In the case that three refrigerators exist in the home network system 1 as slave devices, the refrigerators have the same network code and product code. The master device 30 cannot distinguish the three refrigerators by the fixed addresses. Accordingly, the devices codes are provided so that the slave devices and/or master devices which are the same products can be distinguished from each other.

The cluster code is a logical address code assigned according to a different standard from the classifications set by the network codes described above. In detail, when the user of the home network system 1 intends to turn off the whole products in a predetermined area, the products in the area need to be collectively represented. In accordance with the present invention, the home network system 1 introduces the cluster code. As described above, the applicable standard can be an installation area of the products (for example, living room, kitchen, veranda, main living room, etc.) or a main user mostly using the products. If the main user mostly using the products takes a trip for quite a long time, the cluster code for indicating the products used by the main user can be used.

The address field further includes a flag. The flag designates the logical address code of the dynamic address field as the device code or cluster code. For example, when the flag is ‘0’, the logical address code of the dynamic address field becomes the device code, and when the flag is ‘1’, the logical address code becomes the cluster code. Because the logical address code is selectively included according to the flag, this field becomes the dynamic address field.

FIG. 4B is a detailed structure view illustrating the address field of FIG. 4A. As shown in FIG. 4B, the MSB of the address field is used as the flag, ‘0’ implies the device code, and ‘1’ implies the cluster code. Therefore, the usage of the logical address for the device code and the cluster code can be switched by setting the value of MSB in the whole address field. In addition, when all bits in each sub-field are set to ‘1’, a group address is assigned. For example, when a product code of a refrigerator is ‘0x01’, ‘0x01FF’ indicates a group address of refrigerators, and ‘0x81XX (X is an unspecific number)’ indicates a group address of refrigerators having the same cluster code.

The device code can be automatically set in each slave device 40 and 42 by the master device 30, and the cluster code can be automatically set by the master device 30. However, the device code and the cluster code are mostly set by the user due to technical problems. Especially, when the main user is decided, the device code and the cluster code are mostly set by the user.

FIG. 4C is an exemplary view illustrating product codes and address ranges of each product. In the address ranges, ‘0XXX00’ implies initial logical address codes of each product, ‘0xXXFF’ implies group addresses of each product, and ‘0xXX01˜0XXFF’ are logical address codes (device codes) assignable to each master device 30 and slave device 40 and 42 in the home network system 1.

The product codes and the initial logical address codes are included in initial addresses and stored in the memory of the constitutional device 50a in shipment. In addition, the product codes and address ranges of each product are stored in the memory of the constitutional device 30a. The logical address codes of each address range are assigned to devices newly connected to the home network system 1 by the control means 38.

The master device 30 must register the network codes, product codes and logical address codes (device codes and cluster codes) of the slave devices 40 and 42 in the nonvolatile memory 34 for communication in the home network system 1.

Although the preferred embodiments of the present invention have been described, it is understood that the present invention should not be limited to these preferred embodiments but various changes and modifications can be made by one skilled in the art within the spirit and scope of the present invention as hereinafter claimed.

What is claimed is:

1. A home network system, comprising:
at least one slave device; and
a master device connected to the slave devices through a predetermined network, the master device and the slave device distinguishing each other and communicating with each other by an address field including a dynamic address field selectively having at least two different kinds of logical address codes to distinguish a plurality of slave devices and master devices.

2. The home network system of claim 1, wherein the address field further comprises a fixed address field having a product code provided for the slave device and the master device.

3. The home network system of claim 2, wherein the fixed address field further comprises a network code field.

4. The home network system of either claim 2 or 3, wherein the fixed address field is stored in a nonvolatile memory before the master device and the slave device are connected to the home network system.

5. The home network system of claim 1, wherein the logical address code is a device code for distinguishing a plurality of slave devices and master devices of the same kind in the home network system.

6. The home network system of claim 5, wherein the device code is set by the master device.

7. The home network system of claim 1, wherein the logical address code is a cluster code for clustering the slave device and the master device according to a predetermined standard.

8. The home network system of claim 7, wherein the standard is an installation area of each device.

9. The home network system of claim 7, wherein the standard is a user of the devices.

10. The home network system of either claim 5 or 7, wherein the address field further comprises a flag for indicating whether the logical address code of the dynamic address field is a device code or cluster code.

11. The home network system of either claim 5 or 7, wherein the master device a nd the s lave device store the device code and the cluster code i n the nonvolatile memory.

12. A storage medium for storing an address field of a home network system, the address field used in the home network system comprised of at least two home appliances comprising a fixed address field having a product code provided for the home appliances, and a dynamic address field selectively having at least two different kinds of logical address codes for distinguishing the home appliances.

13. The storage medium of claim 12, wherein the fixed address field further comprises a network code field.

14. The storage medium of claim 12, wherein the code included in the logical address field is a device code for distinguishing a plurality of home appliances of the same kind.

15. The storage medium of claim 12, wherein the code included in the logical address field is a cluster code for clustering the slave device and the master device according to a predetermined standard.

16. The storage medium of claim 15, wherein the standard is an installation area of each device.

17. The storage medium of claim 15, wherein the standard is a user of the devices.

18. The storage medium of either claim 14 or 15, wherein the address field further comprises a flag for indicating whether the logical address code of the dynamic address field is a device code or cluster code.
